(19) United States
(12) Patent Application Publication
(10) Pub. No.: US 2026/0024699 A1
(43) Pub. Date: Jan. 22, 2026

(54) MULTILAYER CERAMIC ELECTRONIC COMPONENT

(71) Applicant: Murata Manufacturing Co., Ltd., Nagaokakyo-shi (JP)

(72) Inventor: Kota ZENZAI, Nagaokakyo-shi (JP)

(21) Appl. No.: 19/339,678

(22) Filed: Sep. 25, 2025

Related U.S. Application Data
(63) Continuation of application No. PCT/JP2024/011734, filed on Mar. 25, 2024.

(30) Foreign Application Priority Data
Mar. 30, 2023 (JP) 2023-056329

(51) Int. Cl. H01G 2/06; H01G 2/24; H01G 4/30

(52) U.S. Cl. CPC H01G 2/065; H01G 2/24; H01G 4/30

(57) ABSTRACT

A multilayer ceramic electronic component includes a multilayer body including an inner layer portion including dielectric layers and internal electrode layers alternately stacked, two main surfaces opposed to each other along a stacking direction, two end surfaces opposed to each other along a length direction, and two side surfaces opposed to each other along a width direction, two external electrodes connected to the internal electrode layers on the two end surfaces and covering the end surfaces and a portion of the two main surfaces, and two spacers on one of the two main surfaces with the external electrodes interposed therebetween. The spacers each include a metal powder and a phenolic resin.

### CROSS REFERENCE TO RELATED APPLICATIONS

This application claims the benefit of priority to Japanese Patent Application No. 2023-056329 filed on Mar. 30, 2023 and is a Continuation Application of PCT Application No. PCT/JP2024/011734 filed on Mar. 25, 2024. The entire contents of each application are hereby incorporated herein by reference.

### BACKGROUND OF THE INVENTION

### 1. Field of the Invention

The present invention relates to multilayer ceramic electronic components such as multilayer ceramic capacitors, for example.

### 2. Description of the Related Art

Multilayer ceramic capacitors each include an inner layer portion in which dielectric layers and internal electrodes are alternately laminated. Then, dielectric layers defining and functioning as outer layer portions are provided at the top and bottom of the inner layer portion to form a rectangular parallelepiped multilayer body, and external electrodes are provided on both end surfaces in the longitudinal direction of the multilayer body to form a capacitor main body.

Furthermore, in order to suppress the occurrence of “acoustic noise”, multilayer ceramic capacitors are known that each include a spacer that covers a portion of the external electrode on a side of the capacitor main body to be mounted on a substrate (see, for example, Japanese Unexamined Patent Application, Publication No. 2015-216337).

However, when the bonding strength between the capacitor main body and the spacer is weak, the spacer may peel off, which is not sufficient in terms of durability when mounted.

Therefore, development of multilayer ceramic capacitors with high bonding strength between the capacitor main body and the spacer and excellent durability when mounted is demanded.

### SUMMARY OF THE INVENTION

Example embodiments of the present invention provide multilayer ceramic capacitors each with high bonding strength between a capacitor main body and a spacer, and each with excellent durability when mounted.

The present inventor of example embodiments of the present invention has discovered that spacers including phenol resin have high bonding strength with the capacitor main body and excellent durability when mounted.

An example embodiment of the present invention provides a multilayer ceramic electronic component which includes a multilayer body including an inner layer portion in which dielectric layers and internal electrode layers are alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction, two external electrodes each on a corresponding one of the two end surfaces, each connected to the internal electrode layers, and each covering the corresponding one of the two end surfaces and a portion of one of the two main surfaces extending from the corresponding one of the two end surfaces, and two spacers on one of the two main surfaces of the multilayer body, in which the two spacers each include metal powder and phenol resin.

According to example embodiments of present the invention, multilayer ceramic capacitors each with high bonding strength between a capacitor main body and a spacer, and each with excellent durability when mounted are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a diagram showing an external appearance of a multilayer ceramic capacitor 1 according to an example embodiment of the present invention.

FIG. 2 is a cross-sectional view of the multilayer ceramic capacitor 1 taken along the line II-II shown in FIG. 1.

FIG. 3 is a cross-sectional view of the multilayer ceramic capacitor 1 taken along the line III-III shown in FIG. 1.

FIG. 4 is an enlarged cross-sectional view of a spacer 4 shown in FIG. 2.

FIG. 5 is a flowchart showing an example of a manufacturing method of the multilayer ceramic capacitor 1 according to an example embodiment of the present invention.

FIGS. 6A to 6D are diagrams explaining a multilayer body manufacturing step S1, a base electrode layer formation step S2, and a first plated layer formation step S3.

FIGS. 7A to 7D are diagrams explaining a spacer placement step S4 and a second plated layer formation step S5.

FIG. 8 is a cross-sectional view showing the multilayer ceramic capacitor 1 without a second plated layer 32 according to an example embodiment of the present invention.

FIG. 9 is a cross-sectional view of the multilayer ceramic capacitor 1 provided with a reinforcing material 50 according to an example embodiment of the present invention.

FIGS. 10A to 10C are diagrams explaining a reinforcing material placement step S6.

### DETAILED DESCRIPTION OF THE EXAMPLE EMBODIMENTS

Example embodiments of the present invention will be described in detail below with reference to the drawings.

In the following, a multilayer ceramic capacitor 1 will be described as an example embodiment of a multilayer ceramic electronic component according to the present invention, but the present invention is not limited thereto. Also, the drawings may be schematically simplified to explain the content of the present invention, and the ratio of dimensions of the components or between components depicted may not match the ratio of their dimensions described in the specification. Also, components described in the specification may be omitted in the drawings, or the number of components may be reduced in the drawings.

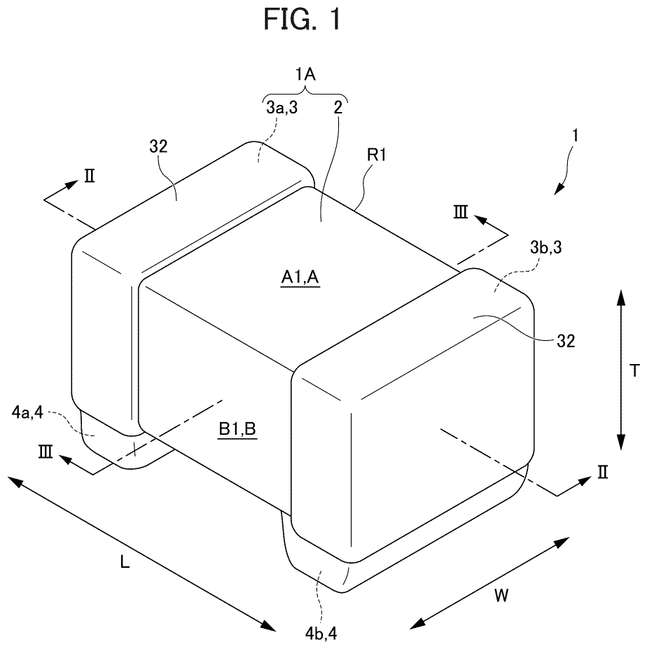

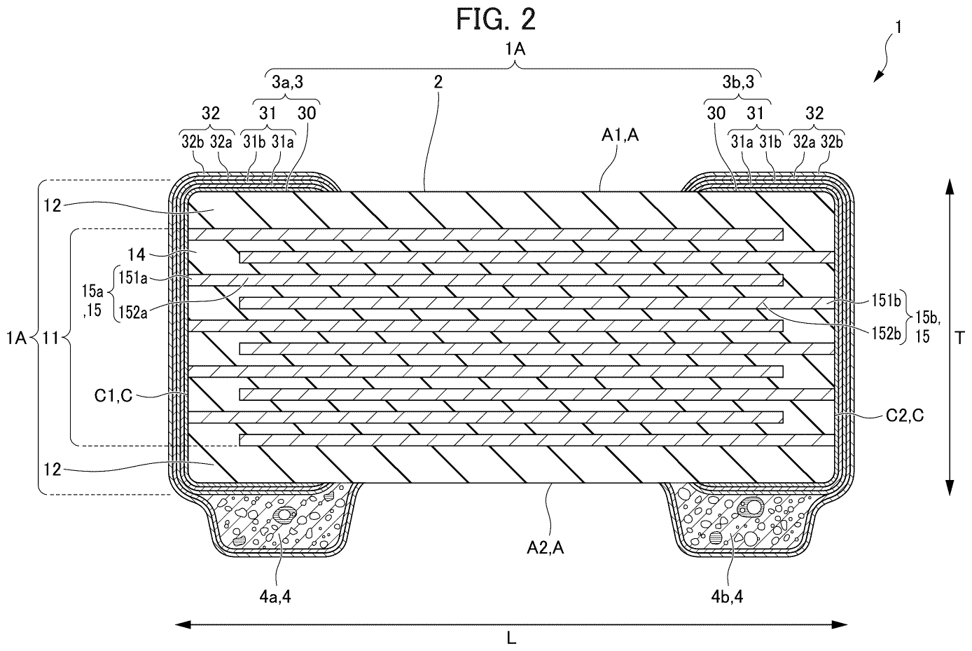

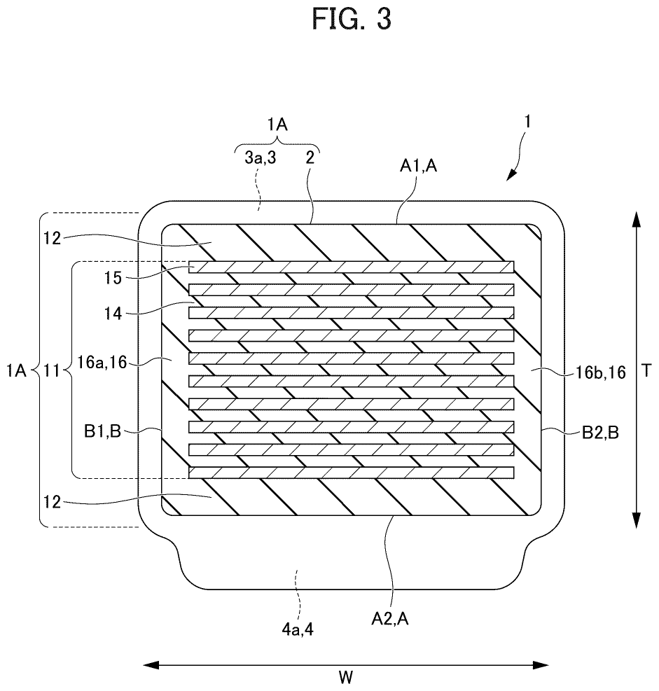

FIG. 1 is a schematic perspective view of a multilayer ceramic capacitor 1 according to an example embodiment of the present invention. FIG. 2 is a cross-sectional view taken along the line II-II in FIG. 1 of the multilayer ceramic capacitor 1 according to an example embodiment of the present invention. FIG. 3 is a cross-sectional view taken along the line III-III in FIG. 1 of the multilayer ceramic capacitor 1 according to an example embodiment of the present invention.

The multilayer ceramic capacitor 1 has a rectangular or substantially rectangular parallelepiped shape, and includes a capacitor main body 1A including a multilayer body 2 and a pair of external electrodes 3 provided at both ends of the multilayer body 2, and at least one spacer 4 attached to the capacitor main body 1A. The multilayer body 2 includes an inner layer portion 11 including dielectric layers 14 and internal electrode layers 15 laminated together.

In the following description, as a term representing the orientation of the multilayer ceramic capacitor 1, the direction in which the pair of external electrodes 3 are provided in the multilayer ceramic capacitor 1 is defined as the length direction L. The direction in which the dielectric layers 14 and the internal electrode layers 15 are stacked is defined as the lamination direction T. The direction intersecting both the length direction L and the lamination direction T is defined as the width direction W. In the example embodiments, the width direction W is orthogonal or substantially orthogonal to both of the length direction L and the lamination direction T.

### Outer Surface of Multilayer Body 2

Among the six outer surfaces of the multilayer body 2, a pair of outer surfaces opposed to each other in the lamination direction T is defined as a first main surface A1 and a second main surface A2, a pair of outer surfaces opposed to each other in the width direction W is defined as a first lateral surface B1 and a second lateral surface B2, and a pair of outer surfaces opposed to each other in the length direction L is defined as a first end surface C1 and a second end surface C2. When there is no need to particularly distinguish between the first main surface A1 and the second main surface A2, they are collectively referred to as main surfaces A, when there is no need to particularly distinguish between the first lateral surface B1 and the second lateral surface B2, they are collectively referred to as lateral surfaces B, and when there is no need to particularly distinguish between the first end surface C1 and the second end surface C2, they are collectively referred to as end surfaces C.

The multilayer body 2 preferably includes rounded ridge portions R1 including corner portions. The ridge portions R1 are portions where two surfaces of the multilayer body 2 intersect, i.e., where the main surface A and the lateral surface B, the main surface A and the end surface C, or the lateral surface B and the end surface C intersect.

### Multilayer Body 2

The multilayer body 2 includes an inner layer portion 11 that generates capacitance, outer layer portions 12 that sandwich the inner layer portion 11 from the lamination direction T, and side gap portions 16 that sandwich the inner layer portion 11 and the outer layer portions 12 from the width direction W.

### Inner Layer Portion 11

The inner layer portion 11 includes dielectric layers 14 and internal electrode layers 15 alternately laminated along the lamination direction T.

### Dielectric Layer 14

The dielectric layers 14 each include a ceramic material. As the ceramic material, for example, a dielectric ceramic with BaTiO₃ as a main component is used.

### Internal Electrode Layer 15

The internal electrode layers 15 include a plurality of first internal electrode layers 15a and a plurality of second internal electrode layers 15b. The first internal electrode layers 15a and the second internal electrode layers 15b are alternately provided. The first internal electrode layers 15a each include a first counter portion 152a opposed to a corresponding one of the second internal electrode layers 15b, and a first extension portion 151a extending from the first counter portion 152a toward the first end surface C1. The end portion of the first extension portion 151a is exposed at the first end surface C1, and is electrically connected to the first external electrode 3a described later. The second internal electrode layers 15b each include a second counter portion 152b opposed to a corresponding one of the first internal electrode layers 15a, and a second extension portion 151b extending from the second counter portion 152b toward the second end surface C2. The end portion of the second extension portion 151b is electrically connected to the second external electrode 3b described later. Electric charge is accumulated in the first counter portion 152a of each of the first internal electrode layers 15a and the second counter portion 152b of each of the second internal electrode layers 15b.

The internal electrode layers 15 preferably include a metal material such as, for example, nickel (Ni), copper (Cu), silver (Ag), palladium (Pd), silver-palladium (Ag—Pd) alloy, and gold (Au).

### Outer Layer Portion 12

The outer layer portion 12 can be made of the same material as the dielectric layers 14 of the inner layer portion 11.

### Side Gap Portion 16

The side gap portions 16 sandwich the inner layer portion 11 and the outer layer portion 12 from the width direction W. The side gap portions 16 include a first side gap portion 16a that defines and functions as the first lateral surface B1 of the multilayer ceramic capacitor 1, and a second side gap portion 16b that defines and functions as the second lateral surface B2 of the multilayer ceramic capacitor 1. The side gap portions 16 can be made of the same material as the dielectric layer 14.

### External Electrode 3

The external electrodes 3 include a first external electrode 3a provided on the first end surface C1, and a second external electrode 3b provided on the second end surface C2. The external electrodes 3 cover not only the end surface C, but also a portion of the main surface A and a portion of the lateral surface B continuous with the end surface C.

As described above, the end portion of the first extension portion 151a of each of the first internal electrode layers 15a is exposed at the first end surface C1, and is electrically connected to the first external electrode 3a. Furthermore, the end portion of the second extension portion 151b of each of the second internal electrode layers 15b is exposed at the second end surface C2, and is electrically connected to the second external electrode 3b. This provides a configuration in which a plurality of capacitor elements are electrically connected in parallel between the first external electrode 3a and the second external electrode 3b.

The external electrodes 3 each include, for example, a base electrode layer 30 and a first plated layer 31. However, it is not necessarily required that the external electrodes 3 include such a layered configuration.

The base electrode layer 30 is formed, for example, by applying and firing an electrically conductive paste including copper (Cu). The base electrode layer 30 may also include, for example, glass and ceramic material.

The first plated layer 31 includes, for example, a first nickel (Ni) plated layer 31a provided on the surface of the base electrode layer 30, and a first tin (Sn) plated layer 31b provided on the surface of the first nickel (Ni) plated layer 31a. The configuration of the first plated layer 31 is not limited thereto.

### Spacer 4

The spacer 4 includes a pair of a first spacer 4a and a second spacer 4b. The first spacer 4a and the second spacer 4b are provided on the second main surface A2, which is a substrate mounting surface of the capacitor main body 1A. The first spacer 4a is provided adjacent to the end surface C1 in the length direction L, and the second spacer 4b is provided adjacent to the end surface C2 in the length direction L. When the substrate mounting surface of the capacitor main body 1A is the first lateral surface B1, the first spacer 4a and the second spacer 4b are provided on the first lateral surface B1, which is a substrate mounting surface of the capacitor main body 1A. The first spacer 4a is provided adjacent to the end surface C1 in the length direction L, and the second spacer 4b is provided adjacent to the end surface C2 in the length direction L.

The spacer 4 is provided on the external electrode 3 of the capacitor main body 1A and on the surface of the second main surface A2 of the multilayer body 2 where the external electrode 3 is not provided. When the substrate mounting surface of the capacitor main body 1A is the first lateral surface B1, the spacer 4 is provided on the external electrode 3 of the capacitor main body 1A and on the surface of the first lateral surface B1 of the multilayer body 2 where the external electrode 3 is not provided.

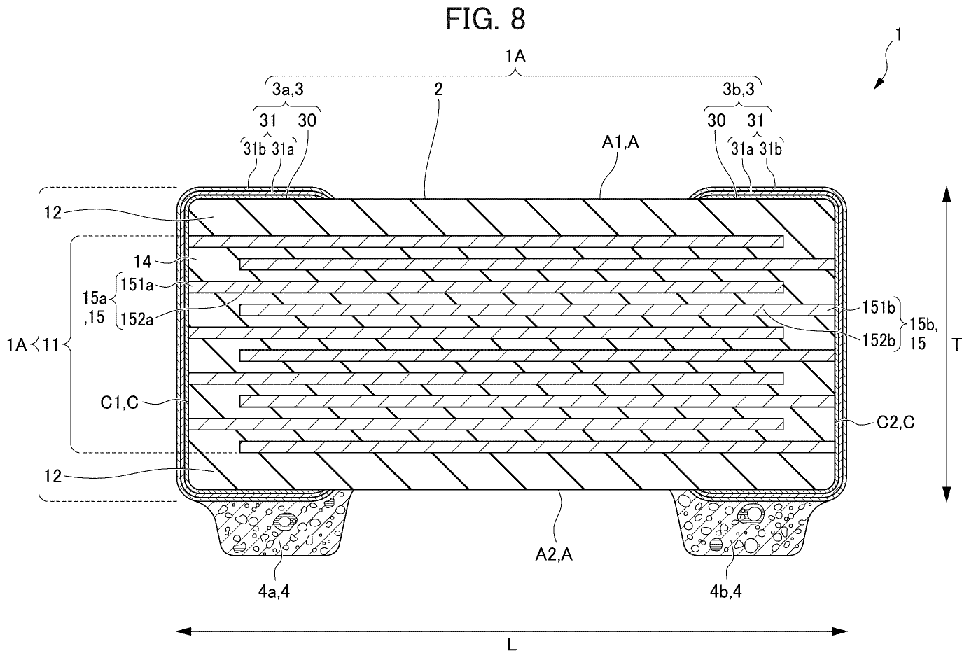

The second plated layer 32 covers the spacer 4 and the external electrode 3, but the present invention is not limited thereto, and the second plated layer 32 may not be provided on the spacer 4 and the external electrode 3 (FIG. 8). When the second plated layer 32 covers the spacer 4 and the external electrode 3, the second plated layer 32 includes, for example, a second nickel (Ni) plated layer 32a and a second tin (Sn) plated layer 32b provided on the surface of the second nickel (Ni) plated layer 32a. The second plated layer 32 is provided on the outer surface of the first tin (Sn) plated layer 31b of the first plated layer 31 in portions where the spacer 4 is not provided, and is provided on the outer surface of the spacer 4 in portions where the spacer 4 is provided. The configuration of the second plated layer 32 is not limited thereto. By providing the second plated layer 32, the bonding strength between the spacer 4 and the capacitor main body 1A is improved.

In an example embodiment of the present invention, the external electrode 3 includes the base electrode layer 30 and the first plated layer 31 that covers the base electrode layer 30, and the spacer 4 is provided on the surface of the first plated layer 31. However, the first plated layer 31 is not necessarily required. For example, the spacer 4 may be provided on the surface of the base electrode layer 30, and the second plated layer 32 may be provided to cover the spacer 4 and the base electrode layer 30. By providing the second plated layer 32, the bonding strength between the spacer 4 and the base electrode layer 30 is improved, and the mechanical strength of the spacer 4 is improved by the second plated layer 32 entering the voids P exposed on the surface of the spacer 4.

For example, the spacer 4 includes, as metal powder, either copper (Cu) or nickel (Ni), and tin (Sn). The copper (Cu) and nickel (Ni) may be coated with silver (Ag). The intermetallic compound formed by adding either copper (Cu) or nickel (Ni), and tin (Sn) does not undergo thermal deformation when the multilayer ceramic capacitor 1 is mounted on a wiring substrate, even during soldering, and can reliably maintain the shape of the spacer 4. In particular, for example, an intermetallic compound formed by adding tin (Sn) to an alloy of copper (Cu) and nickel (Ni) is preferable provided as a component to form the spacer 4.

The metal region MP formed by the metal powder includes phenol resin. The phenol resin coats the intermetallic compound particles and is scattered to fill the gaps between the particles. The phenol resin may not completely coat the intermetallic compound particles. In addition, by using phenol resin, the amount of gas generated during the heat treatment when forming the spacer 4 can be reduced, thus reducing the voids P in the spacer 4. The phenol resin may be exposed on the surface of the spacer 4 and cover at least a portion of the surface of the spacer 4. By covering the surface of the spacer 4 with phenol resin, the smoothness of the surface of the spacer 4 is improved, and the mechanical strength of the spacer 4 is increased.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, or polyoxystyrenes such as polyparaoxystyrene.

The area ratio of phenol resin in the spacer 4 is, for example, preferably about 1% or more and about 20% or less, and more preferably about 5% or more and about 15% or less, in the LT cross-section perpendicular or substantially perpendicular to the width direction W of the spacer 4. When it is less than about 1%, the advantageous effects of the phenol resin cannot be sufficiently achieved, and when it exceeds about 20%, there is a risk that the bonding strength of the spacer to the external electrode will decrease.

As a method for determining the area ratio (%) of phenol resin in the spacer 4, for example, the spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the resin region RP, and the area ratio (%) of phenol resin can be calculated by the formula: (area ratio (%) of phenol resin)=(area of resin region RP)/(area of metal region MP+area of metal powder MF+area of resin region RP+area of void P)×100, from the respective areas of the metal region MP, metal powder MF, resin region RP, and void P.

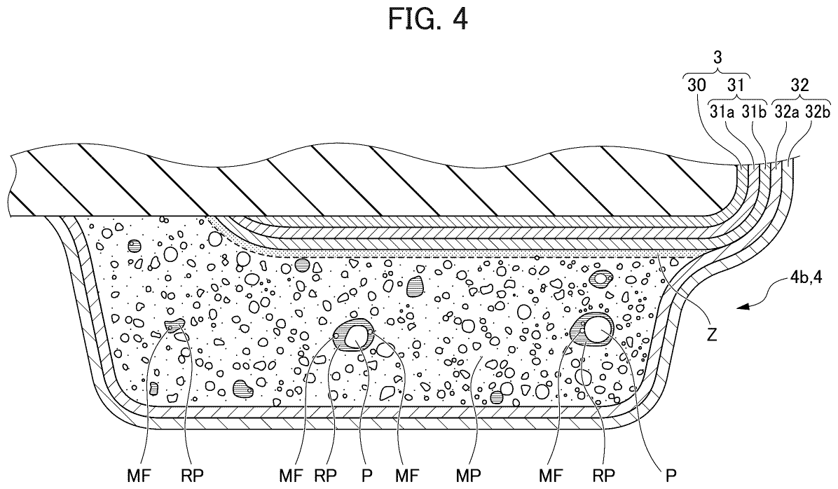

As shown in FIG. 4, the resin region RP defined by the phenol resin may include, for example, metal powder MF. The shrinkage of the phenol resin is reduced or prevented by the metal powder MF, and the shrinkage stress caused by the phenol resin can be reduced.

The spacer 4 preferably has a void ratio of, for example, about 20% or less in the region Z within about 5 μm from the interface with the external electrode 3. By keeping the void ratio low, the bonding area of the spacer 4 that bonds with the external electrode 3 increases, thus improving the bonding strength with the external electrode 3.

As a method for determining the void ratio (%), for example, the spacer 4 is polished in the width direction W to the middle position in the width direction W, and the polished surface is magnified about 50 times with a microscope (BX-51) and photographed with a digital camera for microscopes (DP22 manufactured by Olympus). The obtained image is binarized to separate the metal region MP and the void P portions, and the void ratio (%) can be calculated by the formula: void ratio (%)=(area of void P)/(area of metal region MP+area of metal powder MF+area of resin region RP+area of void P)×100, from the respective areas of the metal region MP, metal powder MF, resin region RP, and void P.

The maximum diameter of the voids P provided inside the spacer 4 is, for example, preferably about ½ or less of the maximum dimension in the thickness of the spacer 4 in the lamination direction T. If the maximum diameter of the voids P exceeds about ½ of the maximum dimension in the thickness of the spacer 4 in the lamination direction T, cracks are likely to occur with the voids P as starting points, thus reducing the strength of the spacer 4. When the substrate mounting surface of the capacitor main body 1A is the first lateral surface B1, the maximum diameter of the voids P provided inside the spacer 4 is, for example, preferably about ½ or less of the maximum dimension in the thickness of the spacer 4 in the width direction W.

### EXAMPLES

Hereinafter, confirmation tests were performed to verify

the advantageous effects of example embodiments of the present invention. However, the present invention is not limited to the following Examples.

### Confirmation Test 1

The specifications of the multilayer ceramic capacitor used in the confirmation test are shown below:
Dimension in length direction L: about 1.6 mm
Dimension in width direction W: about 0.8 mm
Dimension in lamination direction T: about 0.8 mm
Main component of internal electrode: Ni
Main component of base electrode layer: Cu
Plated layer: First layer Ni, Second layer Sn

The spacer is provided on the second layer Sn plated layer.

A comparative test was performed using spacers (Example 1 and Comparative Example 1) formed from the following components:

Example 1: about 31.5 wt % of Cu-10 wt % Ni powder with D50 of about 5 μm, about 58.5 wt % of solder powder with composition of Sn-3 wt % Ag-0.5 wt % Cu with D50 of about 5 μm, and total of about 10 wt % of a combination of phenol resin, solvent, and additives.

Comparative Example 1: about 31.5 wt % of Cu-10 wt % Ni powder with D50 of about 5 μm, about 58.5 wt % of solder powder with composition of Sn-3 wt % Ag-0.5 wt % Cu with D50 of about 5 μm, and total of about 10 wt % of a combination of rosin, solvent, and additives.

Example 1 and Comparative Example 1 were evaluated based on the criteria of the following evaluations 1 to 3.

### Evaluation 1

Samples were mounted on a substrate with solder, and bonding strength was measured using a DAGE5000 (Nordson Advanced Technology Co., Ltd.). At this time, the items were pushed from the direction connecting the first spacer lateral surface and the second spacer lateral surface, and the strengths when the items detached from the substrate were compared. Ten samples were measured, and an average strength less than about 8 N was rated as x (cross symbol indicating poor), about 8 N or more and less than about 11 N as Δ (triangle symbol indicating satisfactory), about 11 N or more and less than about 13N as ○ (circle symbol indicating good), and about 13 N or more as ⊙ (bullseye symbol indicating excellent).

### Evaluation 2

Using a TG-DTA 6300 (Hitachi High-Tech Science Corporation), the resin was heated from room temperature at about 3° C./min in a nitrogen gas atmosphere, and the mass at about 250° C. was measured. A mass reduction rate of about 5% or more from the start of the test was rated as x (cross symbol indicating poor), and less than about 5% was rated as ○ (circle symbol indicating good).

### Evaluation 3

The spacer was polished in the width direction W to the middle of the width direction W. Then, using a microscope (BX-51) connected to a digital camera for microscope (DP22,manufactured by Olympus), the cross-section of the spacer was photographed at a total magnification of about 50 times. The photographed image was binarized, and the respective areas of the metal region MP, metal powder MF, resin region RP, and voids P of the spacer were determined, and the void ratio was calculated by the following calculation formula. When the void ratio at the interface between the spacer and the plated layer (a band-shaped region from a point about 5 μm into the spacer along the shape of the external electrode provided on the second main surface to the junction point between the spacer and the external electrode) was more than about 20%, it was rated as x (cross symbol indicating poor), and when the void ratio was about 20% or less, it was rated as ○ (circle symbol indicating good). Void ratio (%)=Area of voids P/(Area of metal region MP+Area of metal powder MF+Area of resin region RP+Area of voids P)×100

TABLE 1

| | Comparative Example 1 | Example 1 |
|---|---|---|
| EVALUATION 1 | X | ◯ |
| EVALUATION 2 | X | ◯ |
| EVALUATION 3 | X | ◯ |

From Evaluation 1, it was confirmed that Example 1including phenol resin had superior bonding strength compared to Comparative Example 1 including rosin. As shown in Evaluation 2,compared to rosin, phenol resin vaporized in smaller amounts, so that it was possible to reduce the void ratio within the spacer. As a result, it was confirmed that Example 1 had a denser structure within the spacer as shown in Evaluation 3, could increase the bonding area between the external electrode and the spacer, and improved the bonding strength between the external electrode and the spacer. It was confirmed that Comparative Example 1 using rosin had many large voids, making the spacer prone to fracture.

### Confirmation Test 2

The specifications of the multilayer ceramic capacitor used in the confirmation test are shown:
Dimension in length direction L: about 1.6 mm
Dimension in width direction W: about 0.8 mm
Dimension in lamination direction T: about 0.8 mm
Main component of internal electrode: Ni
Main component of base electrode layer: Cu
Plated layer: First layer Ni, Second layer Sn

The spacer is provided on the second layer Sn plated layer.

Examples 2 to 10, in which the amount of phenol resin in Example 1 was changed and the ratio (%) of the area occupied by phenol resin in the spacer was varied as shown in the table below, were evaluated based on Evaluation 1. The ratio (%) of the area occupied by phenol resin was calculated by the following calculation formula. Ratio (%) of area occupied by phenol resin=Area of resin region RP/(Area of metal region MP+Area of metal powder MF+Area of resin region RP+Area of voids P)×100

TABLE 2

| EXAMPLE No. | 2 | 3 | 4 | 5 | 6 | 7 | 8 | 9 | 10 |
|---|---|---|---|---|---|---|---|---|---|
| AREA RATIO | 0.51 | 0.98 | 2.1 | 4.9 | 8.2 | 10.1 | 15.1 | 20 | 25.2 |
| OF PHENOL | | | | | | | | | |
| RESIN | | | | | | | | | |
| EVALUATION 1 | Δ | ◯ | ◯ | ⊚ | ⊚ | ⊚ | ⊚ | ◯ | Δ |

From the results of Confirmation Test 2, it was confirmed that when the resin area ratio of phenol resin was about 0.98% or more and about 20.0% or less, the bonding strength was significantly improved.

In a plan view from the direction perpendicular or substantially perpendicular to the main surface A or lateral surface B on which the spacer 4 is provided, when the spacer 4 is smaller than the external electrode 3, it is preferable to provide a direction identification mark to at least a portion of the spacer 4. The direction identification marks indicates the direction in which opposing the second main surface A2 or the first lateral surface B1 where the spacer 4 is provided toward the wiring board when mounting the multilayer ceramic capacitor 1 on the wiring board, and can include coloring the spacer 4 with a color different from the external electrode 3, printing marks such as a QR code (registered trademark) to identify a direction, or providing a recessed portion in a portion of the multilayer body 2. As coloring, the phenol resin included in the spacer 4 may be exposed on the surface of the spacer 4 to have a color different from the external electrode 3. Even when the spacer 4 is larger than the external electrode 3, a direction identification provided may be provided.

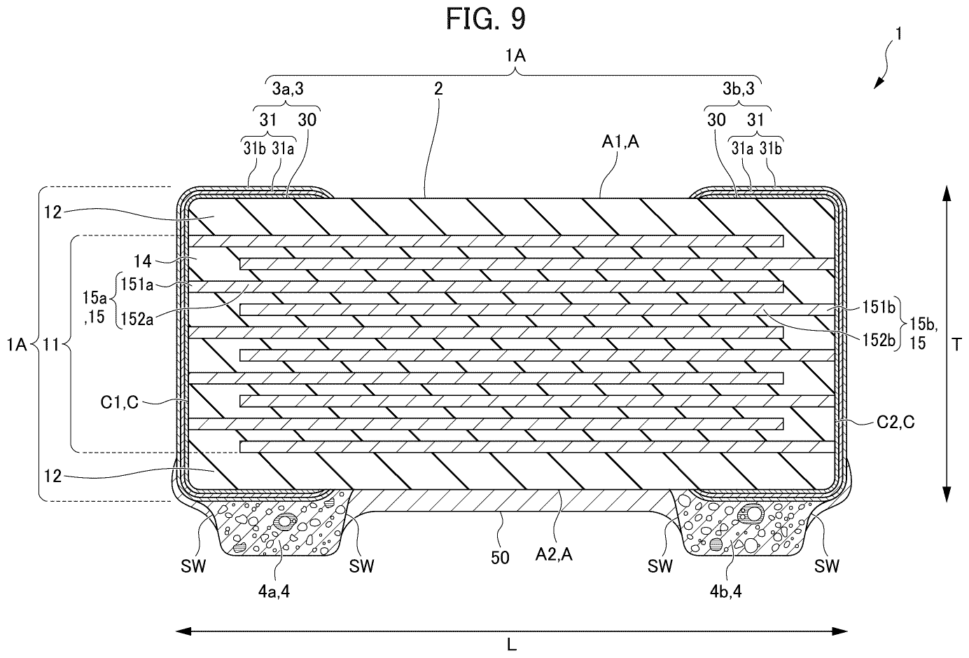

As shown in FIG. 9, between the first spacer 4a and the second spacer 4b, a reinforcing material 50 may be provided so as to cover at least a portion of at least one of the first spacer 4a and the second spacer 4b, and at least a portion of the second main surface A2 or the first lateral surface B1 of the multilayer body 2. By providing the reinforcing material 50, it is possible to improve the bonding strength between the spacer 4 and the external electrode 3, and between the spacer 4 and the multilayer body 2.

The reinforcing material 50 can be provided continuously between the first spacer 4a and the second spacer 4b, but it is not necessary to provide the reinforcing material 50 continuously. For example, the reinforcing material 50 may be provided separately to cover a portion of the first spacer 4a and a portion of the second main surface A2 or the first lateral surface B1 of the multilayer body 2, and another to covers a portion of the second spacer 4b and a portion of the second main surface A2 or the first lateral surface B1 of the multilayer body 2.

The reinforcing material 50 can include, for example, insulating resin. The surface of the insulating resin may be covered with an insulating water repellent treatment agent, for example. By making the reinforcing material with insulating resin, the deflection strength is improved, and by further covering with an insulating water repellent treatment agent, moisture resistance is improved. The insulating resin may include, for example, ceramics, glass, or the like. The reinforcing material may include only of the water repellent treatment agent.

As the material of the reinforcing material 50, for example, epoxy resin can be used as a main component, and phenol resin can be combined as a curing agent. As other curing agents, for example, acid anhydride-based, amine-based, or ester-based curing agents can be used. A curing accelerator may be further added to the epoxy resin.

The reinforcing material 50 can be provided so as to cover the lateral peripheral surface SW of the spacer 4. In this case, it is preferable that the reinforcing material 50 covers the lateral peripheral surface SW of the spacer 4 at a height of, for example, about 5% or more of the length of the spacer 4 in the lamination direction T, while covering the second main surface A2 or the first lateral surface B1 of the multilayer body 2. By covering with the reinforcing material 50 in this manner, the bonding strength of the spacer 4 is improved, and in particular, impact resistance when an impact is applied to the multilayer ceramic capacitor 1 can be improved.

### Method of Manufacturing Multilayer Ceramic Capacitor 1

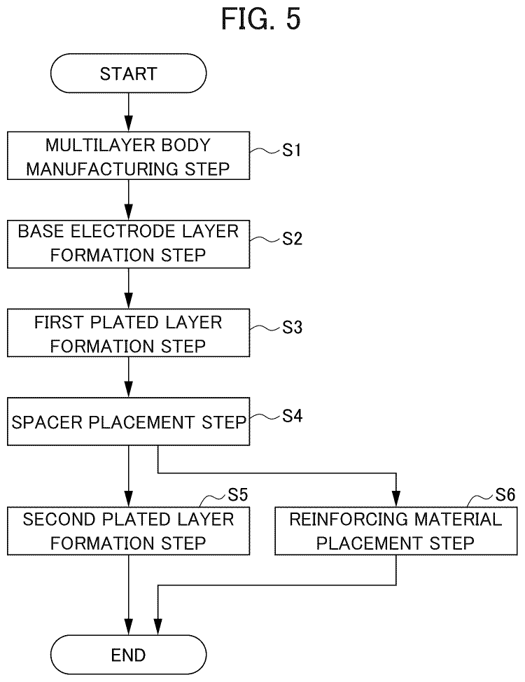

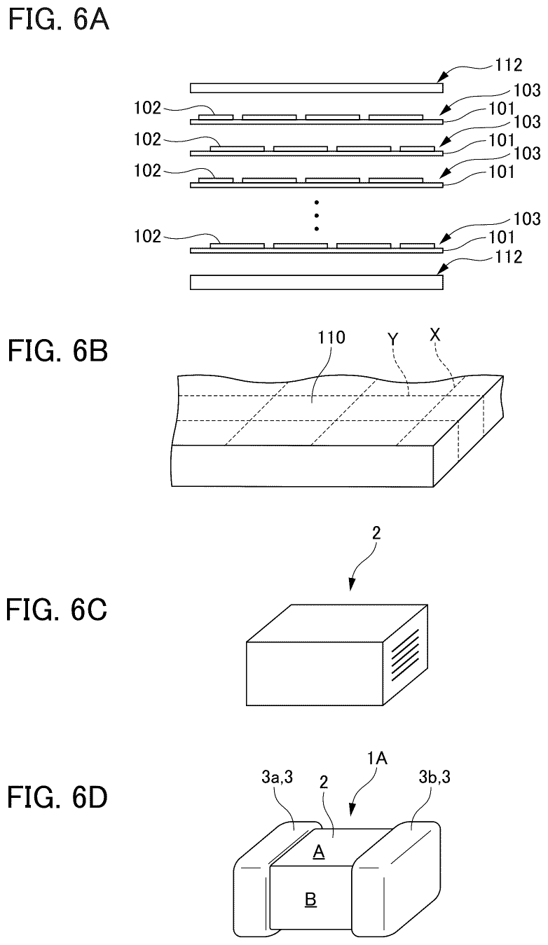

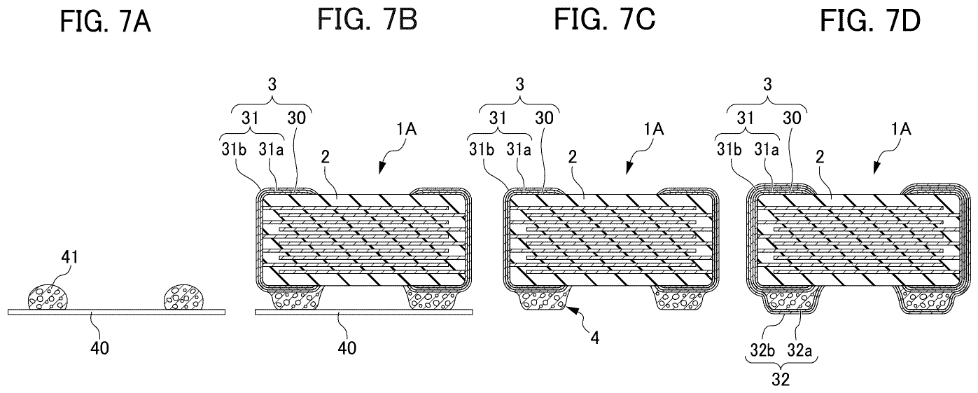

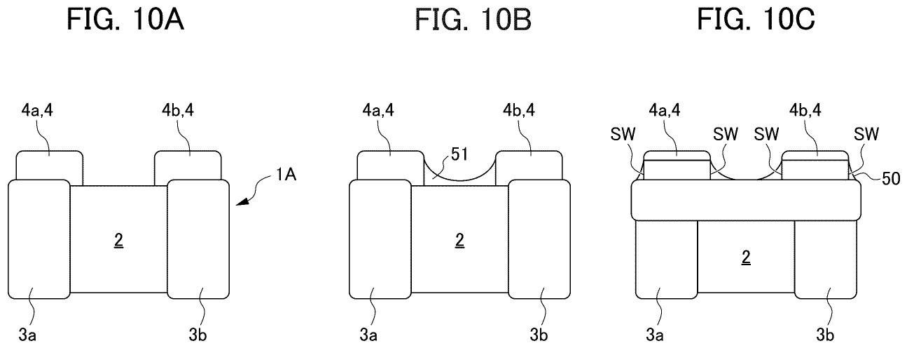

FIG. 5 is a flowchart explaining an example of a method of manufacturing the multilayer ceramic capacitor 1 according to an example embodiment of the present invention. The method of manufacturing the multilayer ceramic capacitor 1 includes, for example, a multilayer body manufacturing step S1, a base electrode layer formation step S2, a first plated layer formation step S3, a spacer placement step S4, and a second plated layer formation step S5. Further, the multilayer ceramic capacitor 1 can include the reinforcing material 50 by subjecting to a reinforcing material placement step S6 after the spacer placement step S4. FIGS. 6A to 6D are diagrams explaining the multilayer body manufacturing step S1, the base electrode layer formation step S2, and the first plated layer formation step S3. FIGS. 7A to 7D are diagrams explaining the spacer placement step S4 and the second plated layer formation step S5. FIGS. 10A to 10C are diagrams explaining the reinforcing material placement step S6.

### Multilayer Body Manufacturing Step S1

A ceramic slurry including ceramic powder, binder, and solvent is formed into a sheet on the surface of a carrier film using, for example, a die coater, gravure coater, micro gravure coater, etc., to create a multilayer ceramic green sheet 101 that defines and functions as the dielectric layer 14. Next, an electrically conductive paste is printed in a strip pattern on the multilayer ceramic green sheet 101 by, for example, screen printing, inkjet printing, gravure printing, etc., and an electrically conductive pattern 102 that defines and functions as the internal electrode layer 15 is printed on the surface of the multilayer ceramic green sheet 101 to create a material sheet 103.

Next, as shown in FIG. 6A, a plurality of material sheets 103 are stacked such that the electrically conductive patterns 102 face in the same direction and the electrically conductive patterns 102 are offset from each other by, for example, about half a pitch in the length direction between adjacent material sheets 103. Furthermore, ceramic green sheets 112 for outer layer portions, which define and function as the outer layer portions 12, are stacked on both sides of the plurality of stacked material sheets 103.

The plurality of stacked material sheets 103 and the ceramic green sheets 112 for outer layer portions are pressed together using, for example, a hydrostatic press or the like to create a mother block 110 as shown in FIG. 6B.

Next, the mother block 110 is cut along cutting lines X and cutting lines Y that intersect the cutting lines X as shown in FIG. 6B to manufacture a plurality of multilayer bodies 2 as shown in FIG. 6C.

### Base Electrode Layer Formation Step S2

Next, a base electrode layer 30 is formed by applying and firing an electrically conductive paste including, for example, copper (Cu) to the end surfaces C of the multilayer body 2. The base electrode layer 30 extends not only on both end surfaces C of the multilayer body 2, but also to the main surfaces A and lateral surfaces B, so as to cover a portion of the main surfaces A adjacent to the end surfaces C. However, the base electrode layer is not limited thereto, and may include other metals or other components, and two base electrode layers may be provided.

### First Plated Layer Formation Step S3

Next, for example, a first nickel (Ni) plated layer 31a is formed on the surface of the base electrode layer 30, and a first tin (Sn) plated layer 31b is provided on the surface of the first nickel (Ni) plated layer 31a to manufacture the capacitor main body 1A shown in FIG. 6D.

### Spacer Placement Step S4

Spacer manufacturing pastes 41 for manufacturing spacers are prepared. The spacer manufacturing pastes 41 include metals such as, for example, copper (Cu), nickel (Ni), tin (Sn) or silver (Ag), phenol resin, solvent, and additives.

Examples of the phenol resin include novolac-type phenol resins such as phenol novolac resin, phenol aralkyl resin, cresol novolac resin, tert-butylphenol novolac resin, or nonylphenol novolac resin, resol-type phenol resin, or polyoxystyrenes such as polyparaoxystyrene.

For forming the spacers 4, a holding substrate 40 as shown in FIGS. 7A to 7D is used. The spacer manufacturing pastes 41 are provided on the holding substrate 40 by, for example, a screen printing method or dispensing method.

Next, as shown in FIG. 7B, the capacitor main body 1A is mounted on the upper surface of the holding substrate 40 in a posture where the second main surface A2 is opposed to the holding substrate 40. At this time, the external electrodes 3 of the capacitor main body 1A are aligned with the spacer manufacturing pastes 41, and the spacer manufacturing pastes 41 adhere to the capacitor main body 1A.

In this state, a heating step is performed. When at least a portion of the metal in the pastes forms an intermetallic compound to form a metal region MP, a portion of the phenol resin is incorporated into the metal region MP, while a portion thereof is discharged from the metal region MP, and the metal region MP is cured, such that spacers 4 bonded to the capacitor main body 1A are formed.

Thereafter, the capacitor main body 1A together with the spacers 4 is separated from the holding substrate 40, resulting in the state shown in FIG. 7C. The manufacturing method is not limited thereto, and the spacer manufacturing paste may be directly provided in a desired shape on the surface of the capacitor main body 1A, followed by heat treatment to form the spacer.

### Second Plated Layer Formation Step S5

Next, for example, a second nickel (Ni) plated layer 32a may be formed on the portion where the first tin (Sn) plated layer 31b is exposed in the capacitor main body 1A, and on the surface of the spacer 4, and further the second tin (Sn) plated layer 32b may be formed on the surface of the second nickel (Ni) plated layer 32a.

### Reinforcing Material Placement Step S6

FIGS. 10A to 10C are diagrams explaining the reinforcing material placement step S6. After the spacer placement step S4, the surface of the capacitor main body 1A on which the spacers 4 are provided is cleaned with a solvent. As shown in FIG. 10A, after the cleaning is completed, the capacitor main body 1A with the spacers 4 is aligned so that the spacers 4 face upward.

Next, as shown in FIG. 10B, an insulating resin layer defining and functioning as the middle portion 51 of the reinforcing material 50 is formed between the first spacer 4a and the second spacer 4b on the capacitor main body 1A with the spacers 4, using, for example, a dispenser or squeegee printing. The amount of wet spreading onto the lateral surface of the spacers 4 can be adjusted by changing the amount of insulating resin.

In order to allow the insulating resin to penetrate into the interface between the spacers 4 and the multilayer body 2, it is possible to perform, for example, vacuum drawing after placing the insulating resin. The amount of penetration can be controlled by changing the time and pressure of the vacuum drawing.

Next, as shown in FIG. 10C, the insulating resin may be applied to cover the outer periphery of the capacitor main body 1A and the outer periphery of the spacers 4. Then, by heating the applied insulating resin at, for example, about 100° C. to about 200° C. for about 20 minutes to about 80 minutes, the insulating resin is cured such that a covered portion by the reinforcing material 50 is formed on the outer periphery of the capacitor main body 1A and the lateral peripheral surfaces SW of the spacers 4. The multilayer ceramic capacitor 1 is manufactured through the above steps.

In the above example embodiments, the reinforcing material 50 directly covers the surfaces of the spacers 4, but the present invention is not necessarily limited thereto. For example, the second plated layer 32 may be provided on the surfaces of the spacers 4, and the reinforcing material 50 may cover the lateral peripheral surfaces SW of the spacers 4 on the surface of the second plated layer 32.

Although example embodiments of the present invention have been described above, the present invention is not limited to the example embodiments, and can be provided in various configurations without departing from the scope of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer body including an inner layer portion in which dielectric layers and internal electrode layers are alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each on a corresponding one of the two end surfaces, each connected to the internal electrode layers, and each covering the corresponding one of the two end surfaces and a portion of each of the two main surfaces extending from the corresponding one of the two end surfaces; and
two spacers on one of the two main surfaces of the multilayer body; wherein
the two spacers each include metal powder and phenol resin.

2. The multilayer ceramic electronic component according to claim 1, wherein, in a cross section of one of the two spacers perpendicular or substantially perpendicular to the width direction, a ratio of an area occupied by the phenol resin is about 1% or more and about 20% or less.

3. The multilayer ceramic electronic component according to claim 1, wherein the phenol resin covers at least a portion of a surface of one of the two spacers.

4. The multilayer ceramic electronic component according to claim 1, wherein a resin region including the phenol resin includes the metal powder.

5. The multilayer ceramic electronic component according to claim 1, wherein each of the two spacers has a porosity of about 20% or less in a region extending about 5 μm from an interface with a corresponding one of the two external electrodes.

6. The multilayer ceramic electronic component according to claim 1, wherein each of the two spacers includes a void, and a maximum diameter of the void is about ½ or less of a maximum dimension in a thickness of one of the two spacers in the lamination direction.

7. The multilayer ceramic electronic component according to claim 1, wherein at least a portion of one of the two spacers includes a direction identification mark.

8. The multilayer ceramic electronic component according to claim 1, wherein a reinforcing material is provided between the two spacers to cover at least a portion of the two spacers and at least a portion of the two main surfaces of the multilayer body.

9. The multilayer ceramic electronic component according to claim 8, wherein the reinforcing material covers a lateral peripheral surface of the two spacers.

10. A multilayer ceramic electronic component comprising:
a multilayer body including an inner layer portion in which dielectric layers and internal electrode layers are alternately laminated, two main surfaces opposed to each other in a lamination direction, two end surfaces opposed to each other in a length direction intersecting the lamination direction, and two lateral surfaces opposed to each other in a width direction intersecting the lamination direction and the length direction;
two external electrodes each on a corresponding one of the two end surfaces, each connected to the internal electrode layers, and each covering the corresponding one of the two end surfaces and a portion of each of the two lateral surfaces extending from the corresponding one of the two end surfaces; and
two spacers on one of the two lateral surfaces of the multilayer body; wherein
the two spacers each include metal powder and phenol resin.

11. The multilayer ceramic electronic component according to claim 10, wherein, in a cross section of one of the two spacers perpendicular or substantially perpendicular to the lamination direction, a ratio of an area occupied by the phenol resin is about 1% or more and about 20% or less.

12. The multilayer ceramic electronic component according to claim 10, wherein the phenol resin covers at least a portion of a surface of one of the two spacers.

13. The multilayer ceramic electronic component according to claim 10, wherein a resin region including the phenol resin includes the metal powder.

14. The multilayer ceramic electronic component according to claim 10, wherein each of the two spacers has a porosity of about 20% or less in a region extending about 5 μm from an interface with a corresponding one of the two external electrodes.

15. The multilayer ceramic electronic component according to claim 10, wherein each of the two spacers includes a void, and a maximum diameter of the void is about ½ or less of a maximum dimension in a thickness of one of the two spacers in the width direction.

16. The multilayer ceramic electronic component according to claim 10, wherein at least a portion of one of the two spacers includes a direction identification mark.

17. The multilayer ceramic electronic component according to claim 10, wherein a reinforcing material is provided between the two spacers to cover at least a portion of the two spacers and at least a portion of the two lateral surfaces of the multilayer body.

18. The multilayer ceramic electronic component according to claim 17, wherein the reinforcing material covers a lateral peripheral surface of the two spacers.
